(19) United States
(12) Patent Application Publication
(10) Pub. No.: US 2023/0137270 A1
(43) Pub. Date: May 4, 2023

(54) METHODS AND APPARATUS FOR CONSTRAINT RULES BASED GROUPING OF ASSETS

(71) Applicant: Copperleaf Technologies Inc., Vancouver (CA)

(72) Inventors: Alejandro Erickson, Burnaby (CA); Paul David Carter, Brackendale (CA); Jo Wag Chow, Burnaby (CA)

(21) Appl. No.: 17/516,039

(22) Filed: Nov. 1, 2021

(51) Int. Cl. G06Q 10/06; G06F 16/28; G06F 16/2455

(52) U.S. Cl. CPC G06Q 10/06315; G06F 16/285; G06F 16/24564

(57) ABSTRACT

Methods and apparatus for asset management are provided. The apparatus, for example, includes an input/output device; and a processor programmed to receive a selection of assets identified via the input/output device, the assets selected based upon search criteria for each asset of a plurality of assets in a network; pre-partition the assets based upon a pre-partition rule determined via the input/output device the pre-partitioning including user selected criteria entered via the input/output device that controls the pre-partition rule; apply a grouping algorithm to the pre-partitioned assets to further sort the assets into groups which includes one or more variables entered via the input/output device that controls the grouping algorithm; and record the groups of assets into a database and transmit a report to the input/output device that includes a statistical summary of how the assets are configured into the groups.

### FIELD

The present disclosure relates, generally, to methods and apparatus for rules based grouping of assets in an asset-management system.

### BACKGROUND

Many businesses face challenges in managing large numbers of pieces of equipment or other assets, e.g., utility poles (e.g., power lines), assets on circuits in a transmission network, pipeline, railroad tracks, cable, etc. The assets maintained by a typical larger organization is a complex system that requires maintenance to continue to operate smoothly to provide production for the organization. Furthermore, many organizations have a sufficiently large pool of assets which can make it impossible to maintain production without careful scheduling of maintenance and replacement of various assets.

For example, some organizations, e.g., a power company, can have in excess of thirty thousand assets (e.g., circuits, relays, transformers, etc.) on a plurality of circuits of an electrical transmission network that need to be managed and maintained and sometimes repaired, upgraded, replaced, or refurbished. For example, some organizations can take preemptive steps (e.g., interventions) to minimize a likelihood of failure of an asset. Accordingly, when assets on a circuit of the electrical transmission network need maintenance, for example, one or more segments, e.g., circuits, of the electrical transmission network may need to be disabled for the maintenance to occur, which can be costly for the power company. As can be appreciated, when multiple interventions for a plurality of assets need to be performed, outage costs associated with disabling the multiple segments on the electrical transmission can be even more costly for the power company.

Many businesses are responsible for populations of assets whose aggregate properties far exceed an amount that can be planned around in a practical way. For example, a utility that manages a million networked power poles, or hundreds of thousands of kilometers of gas distribution pipes, railway assets, roads, power generation assets, pump stations, and/or the like. As such, large populations of assets must be partitioned into smaller more manageable groups around which the business can plan maintenance and capital investments.

Typically, there are things that help make these groups manageable including: (1) Assets in the group are “near” one another in a network, if there is one; and (2) the aggregate properties of the group do not overwhelm the methods and resource units typically employed in the business’s maintenance and/or capital projects.

Partitioning a large asset population manually according to (1) and (2) is an arduous process, if not impossible, yet due to the unique features of each asset population, generalized commercial software systems may not be available for this purpose. Businesses may be forced to commission custom software to partition assets according to specified customized rules. Such custom software is often disproportionately or prohibitively expensive for the problem that it solves, and it only applies to one instance of the problem, which occurred when the software was commissioned. Later, the requirements may change, forcing the business to commission expensive changes to the software. Finally, the custom software’s integration into the business’s asset planning and management software may require manual steps that discourage continuous and fluid use of asset grouping into the asset planning process.

Accordingly, the inventors have provided methods and apparatus that uses Rules-Based Grouping (RBG) for organizing various types of networked assets/entities into groups that each satisfy one or more constraints in an asset management system.

### SUMMARY

Methods and apparatus for asset management are provided. The apparatus, for example, includes an input/output device; and a processor programmed to receive a selection of assets identified via the input/output device, the assets selected based upon search criteria for each asset of a plurality of assets; pre-partition the assets based upon one or more pre-partition rules determined by the user via the input/output device the pre-partitioning including user selected criteria entered via the input/output device that controls the match rule; apply a grouping algorithm to the pre-partitioned assets to further sort the assets into groups which includes one or more variables entered via the input/output device that controls the grouping algorithm; and record the groups of assets into a database and transmit a report to the input/output device that includes a statistical summary of how the assets are configured into the groups.

The method, for instance, includes receiving a selection of assets identified via an input/output device, the selection of assets chosen based upon search criteria for each asset of a plurality of assets in a network; pre-partitioning the assets based upon a match rule, the pre-partitioning including selected criteria entered via the input/output device that controls the match rule; applying a grouping algorithm to the pre-partitioned assets to further sort the assets into groups which includes one or more variables entered via the input/output device that controls the grouping algorithm; and recording the groups of assets into a database and transmitting a report via the input/output device that includes a statistical summary of how the assets are configured into the groups.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 is a block diagram of an asset management apparatus, in accordance with an embodiment of the present disclosure;

FIG. 2 is a flowchart of a method for asset management, in accordance with an embodiment of the present disclosure;

FIG. 3 is a flowchart of method aspects according to the method of FIG. 2, in accordance with an embodiment of the present disclosure;

FIG. 4 is a flowchart of method aspects according to the method of FIG. 2, in accordance an embodiment of the present disclosure;

FIG. 5 is a grouping/bundle diagram using a breath-first search, in accordance an embodiment of the present disclosure;

FIG. 6 is the create, save, process of the apparatus, in accordance an embodiment of the present disclosure;

FIG. 7 is the asset search criteria of the apparatus, in accordance an embodiment of the present disclosure;

FIG. 8 is the Bundle Rule Set pre-partition, aggregate-max, network connection fields of the apparatus, in accordance an embodiment of the present disclosure; and

FIG. 9 is a depiction of a computer system that can be utilized in various embodiments of the present invention.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

The following detailed description describes techniques (e.g., methods, processes, and systems) for Rules-Based Grouping (RBG) of various types of networked assets/entities into groups (also referred to as bundles or bundling herein) that each satisfy one or more constraints in an asset management system. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

In general, a user or entity may have a population of assets that it must manage stored in an asset-management system where each asset has a customizable set of properties. This population of assets may include explicit or implicit descriptions of connections to other assets in a network. Embodiments consistent with the present invention provides a system that receives a selection of all or a subset of the asset population according to search criteria that acts upon the asset properties.

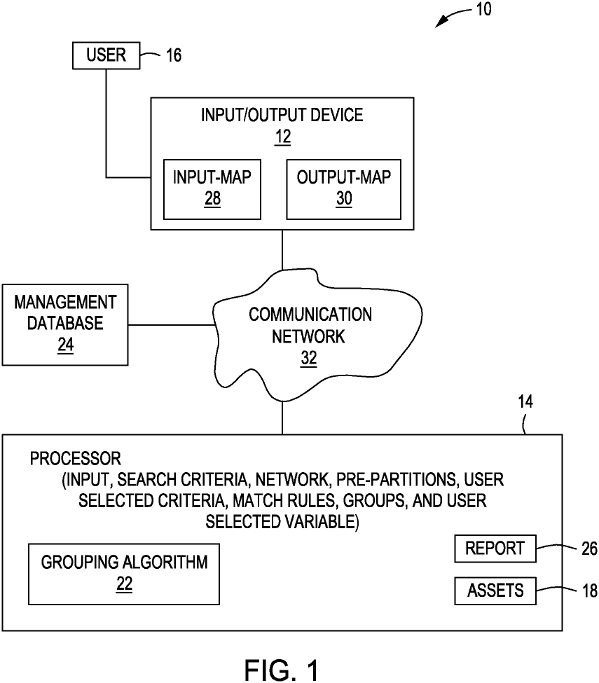

With reference to FIG. 1, in some embodiments consistent with the present disclosure, the asset management apparatus 10 includes an input/output 12 device. The apparatus 10 also includes a processor 14 programmed to receive a selection of assets identified via the input/output device 12, the input including assets 18 selection based upon search criteria for each asset of a plurality of assets. The plurality of assets can be in a network or un-networked, for example. The apparatus 10 further includes pre-partition of the assets 18 based upon a match rule, also referred to as a pre-partition rule, the pre-partitioning including selected criteria entered via the input/output device that controls the match rule. The apparatus 10 additionally includes applying a grouping algorithm 22 to the pre-partitioned assets 18 to further sort the assets into groups which includes one or more variables entered via the input/output device 12 that controls the grouping algorithm 22. For instance, “variables” refer to the aggregate maximums/minimums in various properties entered via the input/output device 12 and describes the groupings of assets that adhere to selected additional properties and/or rules. The apparatus 10 also includes recording the groups of assets 18 into a management database 24 and transmit a report 26 the input/output device 12 that includes a statistical summary of how the assets are configured into the groups.

In some embodiments, the zero or more pre-partition rules that are created to be applied to an asset property to pre-partition the network into parts may include at least one or more of the following:
a) cluster: let X be an asset 18 property that takes on any value from a list of possible values, where the user 16 defines a list of disjoint clusters of values such that two assets must occur in different parts of the pre-partition if their values for property X are in different clusters;
b) match: let Y be an asset 18 property and two assets must occur in different parts of the pre-partition if their values for property Y are not equal; and/or
c) range: let Z be an asset 18 property with a total ordering such that all possible values of Z can be ordered, and the user 16 defines sub-ranges of values such that two assets must occur in different parts of the pre-partition if their values for property Z are not in the same sub-range.

In one embodiment, the user 16 selects a property that describes the network of assets 18 that determines necessary, but not sufficient, requirements for membership in the same group. In another embodiment, each pre-partition is further divided into connected components of the network, where connections that join assets 18 from distinct pre-partition parts are not allowed, and a connected component is a maximal set of network assets within which there is at least one path of network connections between each pair of assets.

In one embodiment, the pre-partition rule includes an aggregate-max on any numerical asset 18 property, where Y is the numerical asset property and the user 16 defines an upper bound on the value of property Y such that the value of Y aggregated over the assets in any group chosen by the grouping algorithm 22, and having more than one asset, may not exceed the bound. In another embodiment, the grouping algorithm 22 reduces sizes of the groups based upon the aggregate-max.

In one embodiment, the apparatus 10 further include an input-map 28 that includes a geographical representation of the assets 18 on the input-map, which enables asset selection by the user 16. In another embodiment, the apparatus 10 also includes an output-map 30 that shows the groups determined by the management apparatus.

In one embodiment, the apparatus 10 communicates over a communications network 32, which enables a signal to travel anywhere within apparatus 10 and/or to any other component/system connected to the apparatus. The communications network 32 is wired and/or wireless, for example. The communications network 32 is local and/or global with respect to apparatus 10, for instance.

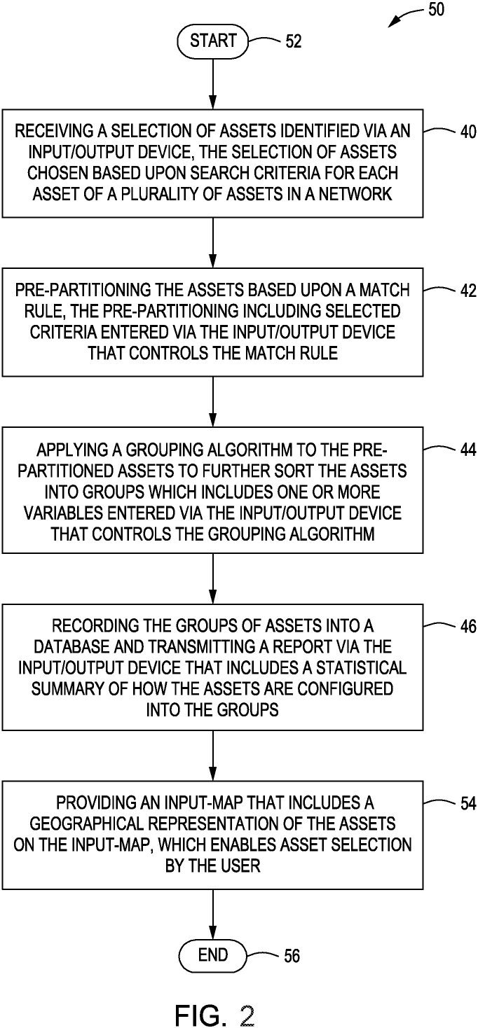

In another embodiment, a method for applying Rules-Based Grouping (RBG) on various types of networked assets/entities into groups that each satisfy one or more constraints in an asset management system is provided, which is now described with reference to flowchart 36 of FIG. 2. The method begins at Block 38 and may include receiving a selection of assets identified via an input/output device, the selection of assets chosen based upon search criteria for each asset of a plurality of assets in a network at Block 40. The method may also include pre-partitioning the assets based upon a pre-partition rule, the pre-partitioning including selected criteria entered via the input/output device that controls the pre-partition rule at Block 42. The method may further include applying a grouping algorithm to the pre-partitioned assets to further sort the assets into groups which includes one or more variables entered via the input/output device that controls the grouping algorithm at Block 44. The method may additionally include recording the groups of assets into a database and transmitting a report via the input/output device that includes a statistical summary of how the assets are configured into the groups at Block 46. The method ends at Block 48.

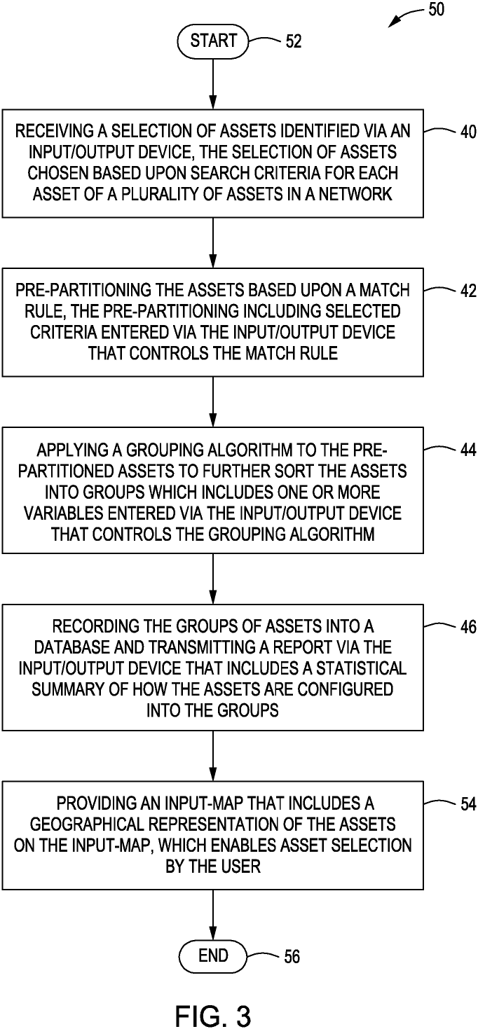

In another method embodiment, which is now described with reference to flowchart 50 of FIG. 3, the method begins at Block 52. The method may include the steps of FIG. 2 at Blocks 40-46. The method may also include providing an input-map that includes a geographical representation of the assets on the input-map, which enables asset selection by the user at Block 54. The method ends at Block 56.

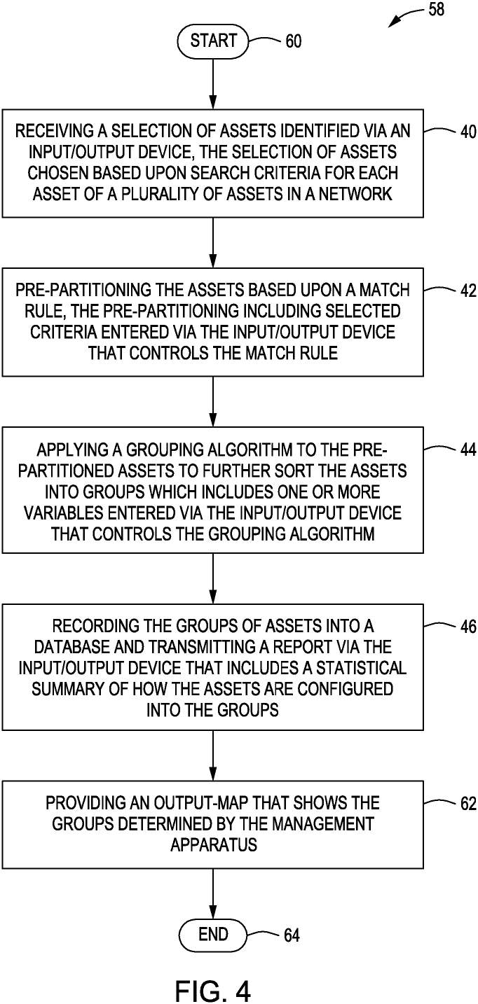

In another method embodiment, which is now described with reference to flowchart 58 of FIG. 4, the method begins at Block 60. The method may include the steps of FIG. 2 at Blocks 40-46. The method may also include providing an output-map that shows the groups determined by the management apparatus at Block 62. The method ends at Block 64.

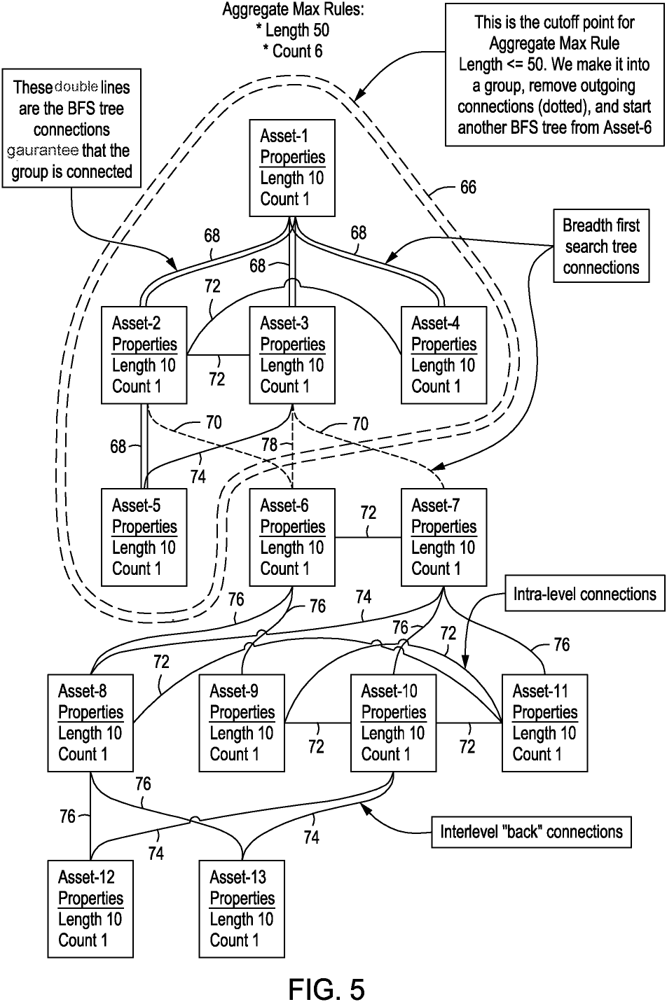

With additional reference to FIG. 5, a working example of the apparatus 10 is now described. In some embodiments, the user has a population of assets stored in an asset-management system where each asset has a customizable set of properties, possibly including explicit or implicit descriptions of connections to other assets in a network. Embodiments consistent with the present invention include an apparatus 10 that allows the user to do the following:
1. Select all or a subset of the asset population according to search criteria that acts upon the asset properties.
2. Create zero or more pre-partition rules, (a-c) below, that apply to an asset property to pre-partition the network into parts:
   Cluster: Let X be an asset property that may take on any value from a list of possible values. The user defines a list of disjoint clusters of values such that two assets must occur in different parts of the pre-partition if their values for property X are in different clusters.
   Match: Let X be an asset property. Two assets must occur in different parts of the pre-partition if their values for property X are not equal.
   Range: Let X be an asset property with a total ordering, such as numbers and dates; that is, all possible values of X can be ordered. The user defines sub-ranges of values such that two assets must occur in different parts of the pre-partition if their values for property X are not in the same sub-range.
3. Select zero or more properties that describe the network of assets that determines necessary, but not sufficient, requirements for membership in the same group. For two distinct assets to occur in the same group, they must be in the same pre-partition part, and they must be connected by a sequence of 1 or more network connections forming a path in the network. If no network properties are selected, assume every pair of assets is connected and that the network forms the “complete” network; as such, the “complete” network can be ignored henceforth.
4. Create zero or more aggregate-max rules on any numerical asset property. Let X be a numerical asset property. The user defines an upper bound on the value of property X such that the value of X aggregated over the assets in any group chosen by the grouping algorithm, and having more than one asset, may not exceed the bound.
5. Select one of several network-partitioning (grouping) algorithms with which to process sets of assets that occur in the connected components of the network that remains after the pre-partitioning step has been applied. In some embodiments, this may be done implicitly.
6. Process the selected assets and rules to obtain a Rule-Based Grouping of the selected assets that is stored in the asset-management system.

At Step 6, the apparatus 10 processes the user-defined rules and selections made in Steps 1-5 as follows:
1. Select assets specified in Step 1. Below this selection of assets is referred to as “the assets”.
2. Pre-partition the assets into parts according to the rules defined in Step 2. Two or more assets occur in the same pre-partition part if, and only if, their properties satisfy all the rules defined in Step 2. For example in some embodiments all rules are applied to all assets. In some embodiments, two or more assets occur in the same pre-partition part if their properties satisfy at least one or more of the rules defined in Step 2.
3. Using the network described in Step 3, divide each pre-partition part arising from Step 8 further into connected components of the network, where connections that join assets from distinct pre-partition parts are not allowed. A connected component is a maximal set of network assets within which there is at least one path of network connections between each pair of assets.
4. Using the appropriate network-partitioning algorithm, possibly selected explicitly in Step 5, partition each connected component of assets arising from Step 9 further, if necessary or desired, into smaller connected components that satisfy any aggregate-max properties defined in Step 4.
5. Record the connected components arising from Step 10 in the asset-management system’s database, and report these as the apparatus’ output, along with a statistical summary of the groupings.

The Steps 1-11 are further clarified with the following example. Steps 1 and 7 example: Suppose the asset-management system has pipe-assets with properties “length”, “diameter”, “material”. The user selects assets in Step 1 satisfying the conditions “diameter at most 0.5 m” and “material is plastic or steel”. Let a(10 m,0.1 m,plastic), b(5 m,0.4 m,plastic), and c(20 m,0.5 m,steel) be the three assets returned by the search, where their properties (length, diameter, material), are listed in the same respective order.

Steps 2 and 8 example: The user defines a Match rule on material; as such, a and b cannot occur in the same pre-partition part as c. The user then defines a Range rule on diameter with the ranges x < 0.2 m and 0.2 m<= x; thus, now have the additional requirement that a cannot occur in the same pre-partition part as b and c. The Range and Match rules taken together, as interpreted in Step 8, yield the pre-partition parts {a}, {b}, {c}. Suppose now that the user changes their mind and drops the Range rule, so the example pre-partition becomes {a,b}, {c} henceforth.

Step 3 example: The user does not define a connection rule, so the network is assumed to be complete. That is, assets a, b, and c are all mutually connected. As an alternative to this, the user could have defined an explicit connection rule on an asset field “connected-asset” with the equivalent description of the network “a connected to b”, “b connected to c”, “c connected to a”.

Step 4 example: The user does not want any group of pipe-assets to exceed a maximum length of 12.0 m.

Step 5 example: The apparatus detects the implicit “complete” network and chooses to apply a partitioning algorithm, when requested, that ignores the network, since it does not come into play.

Steps 9 and 11 example: The network-partitioning algorithm considers the pre-partition part {a,b} and determines that the group {a,b} has aggregate length 15 m, which exceeds the aggregate-max rule of 10 m. Thus, it splits the pre-partition part into two groups {a} and {b}. It then considers the pre-partition part {c}, which has an aggregate length of 20 m. Having no other reasonable choice in the matter, it creates the group {c}. The apparatus saves the groups {a}, {b}, and {c} to the asset-management system and reports a summary that tells the user there were three groups created, along with their minimum, maximum, and average sizes.

In some embodiments, the use of RBG also allows multiple aggregate-max rules. In the example above aggregate diameter <= 0.6 m could be included, so that both the aggregate-max length and diameter rules must be satisfied by each group having more than one asset.

In some embodiments, the use of RBG employs the use of two network-partitioning methods that are referred to here as “Greedy” and “BFS” (breadth-first search). Greedy is used when the network definition is implicit and therefore assumed to be the complete network, and BFS is used otherwise. We describe the two methods.

Greedy Method: Let P be a pre-partition part of assets in a pre-determined order (typically a repeatable, seeded random order). Starting with an empty group g, remove assets from P, in order and one at a time, and add them to g while g satisfies the aggregate-max rules. Repeat the process until no assets remain in P.

BFS Method, see (FIG. 5): Let P be a pre-partition part of assets in a pre-determined order (typically a repeatable, seeded random order). The overall layout of assets and connections between assets shown in FIG. 5 depicts an example of some assets as they were visited, row by row, in breadth-first search order by apparatus 10. The line 68, 70, and 76 connections all represent breadth-first search connections, while line 72, 74 and 78 connections are ignored during a breadth-first search. Line 72 connections represent intra-level connections, and line 74 and 78 represent inter-level back connections. The resulting tree partitions its assets into levels 1, 2 ..., n where every asset except the root asset at level 1 has a guaranteed connection in the breadth-first search tree to an asset in the preceding level. For k <= 1, any subnetwork including the subset of assets that wholly includes the assets of levels 1 through k-1, any of the assets in level k, and the connections between them is guaranteed to be connected. Note that the example assets in FIG. 5 belonged to a connected-component of P, however P may have contained other assets that were similarly organized into their own breadth-first search trees. The group g is built as the breadth-first search tree assets are visited, and it is guaranteed to be connected by using the property of breadth-first search trees described above. Algorithm: Add the root asset to the group g and visit assets in P in breadth-first search order, adding visited assets to g and removing them from P while g satisfies the aggregate-max rules. At this point either there are no more assets to visit, in which case g contains the entire breadth-first search tree, or the asset currently being visited cannot be added to g without violating the aggregate-max rule. In any case, connections from the remaining assets of P to assets in g are severed, and g is reported as one of the groups found by the grouping algorithm. Repeat the process until no assets remain in P; end Algorithm. In FIG. 5 the line 66 lasso encircles assets that have been added to g at the point where the next asset (Asset-6) in the breadth-first search cannot be added to g due to the example aggregate-max rule requiring the total length property of the group to be at most 50. The dotted line 70 and 78 connections from assets in g to the remaining assets in P are severed, and the next breadth-first search tree is processed with Asset-6 as its root. Note that although the whole breadth-first search tree is drawn for FIG. 5, the algorithm only visits Assets 1 through 6 in order to build the depicted group g. Furthermore, the next breadth-first search tree rooted at Asset-6 has a different layout; for example, Assets 7, 8, and 9 (in that order) form level 2 of the next tree, and so on.

In other words, as described above, after pre-partitioning, and separating out connected components of each pre-partition, the system is left with a number of connected graphs to partition. Let G=(V,E) be a connected undirected graph whose nodes/assets have a weight vector (AggregateMax rule properties), and whose edges have a weight (which may represent distance, or may trivially be equal to 1; edge-weights may be defined, in some embodiments, as part of the connection rule). We wish to partition the nodes V into subsets, such that each subset S has the following properties:
S induces a connected subgraph of G, meaning that between each pair of nodes in S there is a path along edges and nodes in G whose nodes all belong to S.
The sum of the weights of nodes in S does not exceed the AggregateMax rule(s).

Additionally, there are some qualitative and quantitative properties that S, or the partition, may possess. Examples of these are:
The subsets S tend to induce low-diameter (weighted version) subgraphs in G. This corresponds to wanting all nodes in the induced subgraphs to be near each other, by some measure.
The edge-weight of the induced subgraphs is maximized (or minimized).
If distinct subsets S and T are connected by an edge, then S union T violates an AggregateMax rule. This helps avoid degenerate solutions such as each node of G inducing its own subgraph.
The partition maximizes some function of the aggregate node-weight-vectors of S. This may also help optimize the size or some other quality of the subsets.
Minimize the number of subsets in the partition.
Subsets S tend to have high conductance (a graph metric on how well “knit” a graph is).

This problem can be solved heuristically, with methods that yield some or all of the qualities listed above, and it can also be formulated as an optimization problem, by introducing some or all of the qualities listed above as formal constraints. In the former category is described the BFS algorithm, and the greedy algorithm (in the special case of the complete graph).

In other embodiments, the use of RBG employs the use of methods/algorithms to partition the graphs other than the BFS method/algorithms described above. Specifically, other embodiments to partition the graphs may include, for example: random restarts; maximum weight hierarchical matching; parallel BFS; random or semi-random walk; machine learning; mixed integer linear programs/programming, and the like. Some of these embodiments are described below in further detail.

Random restarts: The BFS algorithm may yield different results if a different ordering of the nodes is used. The BFS algorithm can be run repeatedly with the nodes reordered for each run. The resulting partitions can be compared (such as by counting the number of subsets), and a favoured partition can be chosen. Similarly, random restarts apply to other heuristic algorithms where certain choices, such as the ordering of the nodes, yield different results.

Maximum weight hierarchical matching: A matching is a set of edges of G that do not share any end-point nodes. A maximum weight matching (found either by linear optimization or heuristics) is one whose aggregate edge-weights is maximum. In this algorithm we find a maximum weight matching of G (or close to maximum), and collapse each edge in the matching, making a new “super” node out of its end-nodes, and deleting any edges that are now “doubled”. This yields a graph G_1, where edge weights are either the same as those of G, or the sum of weights on two or more edges that were “doubled” during the collapsing. Similarly, the node-weight-vectors of G _1, are either original, or the sum of weight vectors of nodes that were combined in the collapsing. Naturally, two nodes cannot be combined if the new weight vector would violate an AggregateMax rule. We continue in this fashion creating G_2 from G_1, etc., until no further collapsing can be done. The (super) nodes of the final graph in this sequence yield the subsets S.

Random or semi-random walk: The sets S can be built via random walks, or semi random walks (making weighted choices). This may work better on very large graphs (with 1 Million nodes or more).

Machine learning: A neural network or other ML model may be trained to partition G such that the chosen subsets have desirable properties..

Mixed Integer Linear Program (MILP): An optimal solution can likely be achieved with a MILP optimizer. One high-level procedure would be as follows. For some number of parts k, define k binary decision variables for each edge and node in G. The kth of these variables is equal to 1 in the solution if, and only if, that node or edge is part of the kth induced subgraph. The objective function might optimize something like total edge weight used in induced subgraphs, or the L2 norm (sum of squares) of edge weights used in induced subgraphs. The constraints enforce the graph structure of G (which nodes terminate which edges), the enforcement of the AggregateMax rules, and the connectedness of induced subgraphs. Connectedness is definitely the most complex thing here, but it appears to be doable, even if through special techniques to deal with combinatorial explosion of constraints. For each k=1,2,3,4,... the optimization to partition G into at most k parts is run until one of the runs yields a feasible solution, which is output as the desired partition.

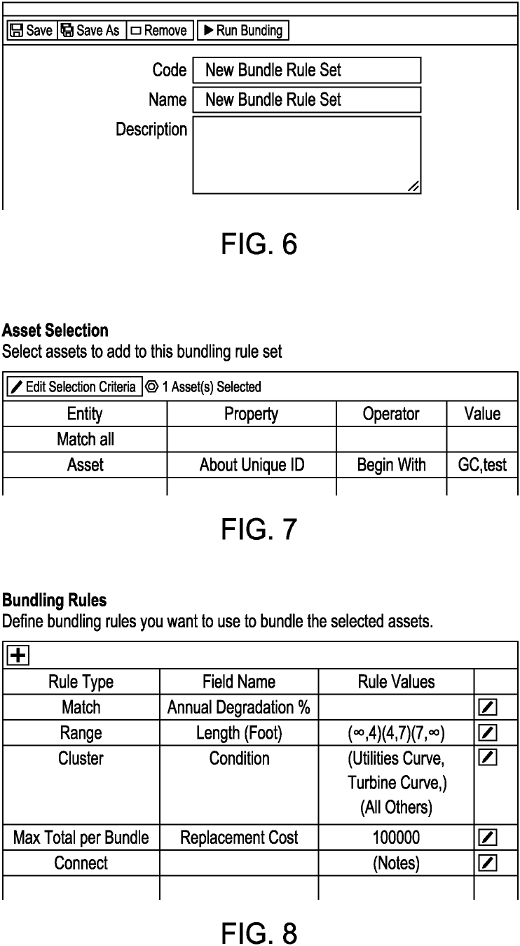

In some embodiments, the use of RBG allows the user to perform Steps 1-11 in a dedicated dialogue in the asset-management system (see FIGS. 6-8). The asset-search criteria, pre-partition rules, network definition, and aggregate-max rules can be saved and stored in the system 10 as a bundle-rule set. Note that the bundle-rule set will also be referred to as the group rule set. Using the dialogue in FIG. 6 the user 106 creates a new bundle-rule set by giving it a Name, a unique identifier called a Code, and (optionally) a description. FIG. 6 also shows 4 administrative actions that can be executed, including: “Save”, to save changes made to a new or existing bundle-rule set; “Save As”, to create a saved copy of an existing bundle rule-set; “Revert”, to revert unsaved changes that have been made to an existing bundle-rule set; and “Run Bundling” to perform Step 6. The apparatus 10 can save, load, and edit multiple bundle-rule sets simultaneously (not depicted). Using the dialogue in FIG. 7 the user 106 enters and saves asset search criteria that selects assets to be processed by RBG from a larger database of assets; for example, all assets of type “Gas Main” with an in-service date no earlier than 1970-01-01. Using FIG. 8 the user 106 defines pre-partition rules, the network, and aggregate max rules, if desired. When the apparatus 10 processes a bundle-rule set (Step 7-11), the groups that are determined and stored by the apparatus are associated with the bundle-rule set they originated from. FIG. 8 is an example and one skilled in the art would understand that other types of rules and rules sets may be used. For example, the rules can have sets of ranges or selected values of physical attributes, time quantity identifier, monetary value, maintenance threshold, and/or the like.

Steps 1-11 allow for several optional features and variations. Steps 1-4 may operate on asset properties that are not explicitly or permanently stored in the asset-management system 10 but are instead calculated by the Value Framework (not described here) when they are needed. For example, suppose an asset property expresses the proximity of a power pole to a road, and another property expresses the density of traffic on that road. A third property may be calculated using the Value Framework, that expresses the risk, in dollars, of the power pole doing harm to a person or their belongings.

Step 2 describes three of many possible optional pre-partition rule types. One example could be a rule that operates on more than one property, such as one requiring a Match on manufacturer if, and only if, the material of the asset is “Plastic”. Another example could be a rule similar to the Range rule, but with non-contiguous ranges; e.g., given a numerical asset property X, define numerical ranges such as [1-3] and [5-7], so that two assets occur in the same pre-partition if, and only if, their values of property X lie in either the range [1-3] or [5-7]. Another example could be a 2-dimensional Range-like rule, that operates on two numerical properties, such as GPS co-ordinates, which could be used to partition assets into geographical regions.

Individual pre-partition rules can optionally be enforced as sufficient conditions rather than necessary conditions for membership in the same pre-partition part. This relaxed notion of a pre-partition rule can be applied to any rule described thus far. Where Step 2 stipulates that two assets occur in different parts of the pre-partition if they do not satisfy the rule, apparatus 10 would instead say that two assets may occur in the same part of the pre-partition if they do satisfy the rule. The relaxation would make the pre-partition step non-deterministic, in general, allowing the apparatus to choose which rules to apply and how to apply them, and effectively turn the rules into suggestions.

One final option for Step 2 pre-partition rules (among many others that are possible) would be to interpret the complement of the rule. For example, apparatus 10 can define the Not Cluster rule by changing the language of the Cluster rule to “two assets must occur in different parts of the pre-partition if their values for property X are in the same cluster”. Similarly, the Not Match rule would be defined by changing the language of the Match rule to “two assets must occur in different parts of the pre-partition if their values for property X do match”. This option also introduces non-determinism in the pre-partition step. For example, consider an asset property Y that can take on any of the 3 values “small”, “medium”, “large”. As such, the Not Match rule on this property yields no pre-partition part with more than 3 assets, since any larger set of assets will contain two assets with the same value for property Y. Given 4 assets and their values for Y, labelled a(small), b(medium), c(large), d(small), two reasonable partitions exist; i.e., the pre-partitions {a,b,c}, {d} and {d,b,c}, {a} both feature pre-partition parts of the same respective sizes.

Step 3 provides for two ways of describing a network, but there are many other possible ways. For example, rather than linking neighboring assets through asset properties, a separate table in apparatus 10 can describe linked pairs of assets, or even mutually-connected sets of assets. Alternatively, given additional display features, the user can describe the network while using the tool, for example with a graphical aid or lasso tool, whereby they draw a lasso around assets that are connected in the network. Finally, the user could use GIS data and a “distance”, as interpreted by some metric such as rush-hour driving-time or Euclidean, so that any two assets within the specified distance are connected in the network.

In Step 4 the aggregate-max rule is one of many possible constraints that can be applied to the asset groups chosen by a network-partitioning algorithm. As used herein, the constraints may generally be any function of the assets of the group that has to satisfy some condition. For example, property-aggregation techniques other than addition can be used (such as multiplication), aggregate constraints need-not be upper bounds, and the aggregation need not be monotonic. For example, suppose apparatus 10 aggregates property X with multiplication and assets a,b,c have X values 5.0, 0.2, and 2.0, respectively. As such, {a,b} has aggregate value 5.0*0.2=1.0, and {a,b} has aggregate value 1.0*2.0=2.0. Apparatus 10 is not limited to property-aggregation either; apparatus 10 may require a balanced partition, in which every group resulting from the same connected-component of the pre-partition has a similar size (or similar aggregate property); apparatus 10 may require a maximum-diameter partition (or one or more of many other network properties) in which the length of the shortest network-path between each pair of assets in a group is bounded by some maximum length.

In Step 5 there are many possible network-partitioning methods besides Greedy and BFS (described above). Indeed, some of the optional constraints on groups described above as optional features in Step 4 require other methods to be used in Step 5. There may be an explicit choice of method or the apparatus 10 can make a choice based on the constraints requested in Step 4 and any additional system configuration. The additional display features mentioned at options for Step 3, above, may include a geographical representation of the assets, where each asset is a marker on an interactive map embedded in the bundle-rule set dialogue. The map could allow interactions such as zooming, scrolling, as well as asset selection. In addition, the map could display a summary of relevant asset-properties, especially those used in the bundle-rule set, when the user clicks the asset’s marker. The map could also color-code the visible asset-markers according to the pre-partition rules, as well as show the network connections according to the connection rule.

Similar to the above interactive map input-display feature, we can optionally have an interactive map output-display. The output-map could have the same features as the input-map, as appropriate, and would additionally show the groups determined by the apparatus. Groups can be shown either through color coding of markers or network connections, or possibly on mouseover of one of the assets in the group. The alternative output display can also allow the user to edit the groups (with or without enforcement of any constraints).

Additional statistics, such as a histogram of group-sizes, or statistics by geographical region, can be added to the summary output in Step 11.

Finally, with the above in mind, RBG need not be restricted to assets. Indeed, the invention applies to any type of entity in which the entities have properties and may or may not form a network via some arbitrary association between entities.

An example application of the invention is where a gas distribution utility wants to group interconnected pipe-assets into manageable units of at most a specified number of feet in aggregate length, and the same material cluster, administrative region, and other properties.

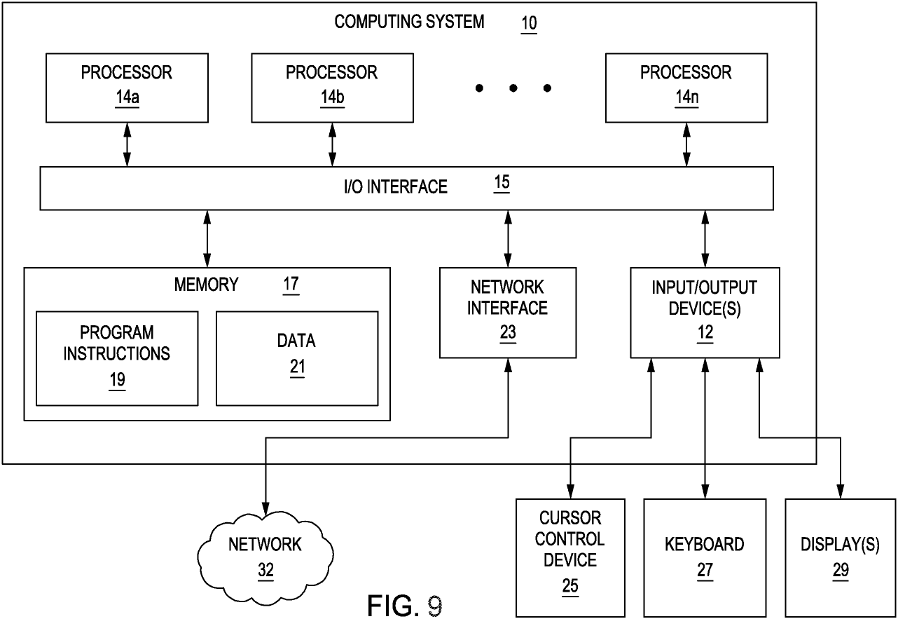

FIG. 9 is a depiction of a computer system/apparatus 10 that can be utilized in various embodiments of the present invention. The computer system 10 comprises substantially similar structure comprising servers or electronic devices in the aforementioned embodiments.

Various embodiments of methods and system for routing active communication session data, as described herein, may be executed on one or more computer systems, which may interact with various other devices. One such computer system is computer system 10 illustrated by FIG. 9, which may in various embodiments implement any of the elements or functionality illustrated in FIGS. 1-8. In various embodiments, computer system 10 may be configured to implement methods described above. The computer system 10 may be used to implement any other system, device, element, functionality or method of the above-described embodiments. In the illustrated embodiments, computer system 10 may be configured to implement methods 36, 50, and 58 as processor-executable executable program instructions 19 (e.g., program instructions executable by processor(s) 14) in various embodiments.

In the illustrated embodiment, computer system 10 includes one or more processors 14a-14n coupled to a system memory 17 via an input/output (I/O) interface 15. Computer system 10 further includes a network interface 23 coupled to I/O interface 15, and one or more input/output devices 12, such as cursor control device 25, keyboard 27, and display(s) 29. In some embodiments, the keyboard 27 may be a touchscreen input device.

In various embodiments, any of the components may be utilized by the system 10 to route active communication session data described above. In various embodiments, a user interface may be generated and displayed on display 29. In some cases, it is contemplated that embodiments may be implemented using a single instance of computer system 10, while in other embodiments multiple such systems, or multiple nodes making up computer system 10, may be configured to host different portions or instances of various embodiments. For example, in one embodiment some elements may be implemented via one or more nodes of computer system 10 that are distinct from those nodes implementing other elements. In another example, multiple nodes may implement computer system 10 in a distributed manner.

In different embodiments, computer system 10 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 10 may be a uniprocessor system including one processor 14, or a multiprocessor system including several processors 14 (e.g., two, four, eight, or another suitable number). Processors 14 may be any suitable processor capable of executing instructions. For example, in various embodiments processors 14 may be general-purpose or embedded processors implementing any of a variety of instruction set architectures (ISAs). In multiprocessor systems, each of processors 14 may commonly, but not necessarily, implement the same ISA.

System memory 17 may be configured to store program instructions 19 and/or data 21 accessible by processor 14. In various embodiments, system memory 17 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 17. In other embodiments, program instructions and/or data may be received, sent or stored upon different types of computer-accessible media or on similar media separate from system memory 17 or computer system 10.

In one embodiment, I/O interface 15 may be configured to coordinate I/O traffic between processor 14, system memory 17, and any peripheral devices in the device, including network interface 23 or other peripheral interfaces, such as input/output devices 12. In some embodiments, I/O interface 15 may perform any necessary protocol, timing or other data transformations to convert data signals from one component (e.g., system memory 17) into a format suitable for use by another component (e.g., processor 14). In some embodiments, I/O interface 15 may include support for devices attached through various types of peripheral buses, such as a variant of the Peripheral Component Interconnect (PCI) bus standard or the Universal Serial Bus (USB) standard, for example. In some embodiments, the function of I/O interface 15 may be split into two or more separate components, such as a north bridge and a south bridge, for example. Also, in some embodiments some or all of the functionality of I/O interface 15, such as an interface to system memory 17, may be incorporated directly into processor 14.

Network interface 23 may be configured to allow data to be exchanged between computer system 10 and other devices attached to a network (e.g., network 32), such as one or more external systems or between nodes of computer system 10. In various embodiments, network 32 may include one or more networks including but not limited to Local Area Networks (LANs) (e.g., an Ethernet or corporate network), Wide Area Networks (WANs) (e.g., the Internet), wireless data networks, cellular networks, Wi-Fi, some other electronic data network, or some combination thereof. In various embodiments, network interface 23 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 12 may, in some embodiments, include one or more display terminals, keyboards, keypads, touchpads, touchscreens, scanning devices, voice or optical recognition devices, or any other devices suitable for entering or accessing data by one or more computer systems 10. Multiple input/output devices 12 may be present in computer system 10 or may be distributed on various nodes of computer system 10. In some embodiments, similar input/output devices may be separate from computer system 10 and may interact with one or more nodes of computer system 10 through a wired or wireless connection, such as over network interface 23.

In some embodiments, the illustrated computer system may implement any of the methods described above, such as the methods illustrated by the flowchart of FIGS. 2, 3, and 4. In other embodiments, different elements and data may be included.

Those skilled in the art will appreciate that computer system 10 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. Computer system 10 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 10 may be transmitted to computer system 10 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. An asset management apparatus comprising:
an input/output device; and
a processor programmed to:
receive a selection of assets identified via the input/output device, the assets selected based upon search criteria for each asset of a plurality of assets;
pre-partition the assets based upon a pre-partition rule defined via the input/output device, the pre-partitioning including user selected criteria entered via the input/output device that controls the pre-partition rule;
apply a grouping algorithm to the pre-partitioned assets to further sort the assets into groups which includes one or more variables entered via the input/output device that controls the grouping algorithm; and
record the groups of assets into a database and transmit a report to the input/output device that includes a statistical summary of how the assets are configured into the groups.

2. The asset management apparatus of claim 1, wherein the one or more variables are aggregate maximums/minimums in various asset properties entered via the input/output device and describes the groupings of assets that adhere to selected additional properties and/or rules.

3. The asset management apparatus of claim 1, wherein the pre-partition rule includes at least one of the following:
cluster: let X be an asset property that takes on any value from a list of possible values, where a list of disjoint clusters of values are defined such that two assets must occur in different parts of the pre-partition if their values for property X are in different clusters;
match: let Y be an asset property and two assets must occur in different parts of the pre-partition if their values for property Y are not equal; and
range: let Z be an asset property with a total ordering such that all possible values of Z can be ordered, and the sub-ranges of values are defined such that two assets must occur in different parts of the pre-partition if their values for property Z are not in the same sub-range.

4. The asset management apparatus of claim 3, wherein a property that describes a network of assets that determines necessary, but not sufficient, requirements for membership in the same group is selected.

5. The asset management apparatus of claim 3, wherein any pre-partition rule can optionally be enforced as at least one of a sufficient condition rather than a necessary condition for membership in the same pre-partition part and a complement of the pre-partition rule.

6. The asset management apparatus of claim 3, wherein each pre-partition is further divided into connected components of the network, where connections that join assets from distinct pre-partition parts are not allowed, and a connected component is a maximal set of network assets within which there is at least one path of network connections between each pair of assets.

7. The asset management apparatus of claim 1, wherein the match rule includes an aggregate-max on any numerical asset property, where Y is the numerical asset property and an upper bound on the value of property Y is defined such that the value of Y aggregated over the assets in any group chosen by the grouping algorithm, and having more than one asset, may not exceed the bound.

8. The asset management apparatus of claim 1, wherein the grouping algorithm reduces sizes of the groups based upon the aggregate-max.

9. The asset management apparatus of claim 1 further comprising an input-map that includes a geographical representation of the assets on the input-map, which enables asset selection by a user.

10. The asset management apparatus of claim 1 further comprising an output-map that shows the groups determined by the management apparatus.

11. A method for asset management comprising:
receiving a selection of assets identified via an input/output device, the selection of assets chosen based upon search criteria for each asset of a plurality of assets;
pre-partitioning the assets based upon a pre-partition rule, the pre-partitioning including selected criteria entered via the input/output device that controls the pre-partition rule;
applying a grouping algorithm to the pre-partitioned assets to further sort the assets into groups which includes one or more variables entered via the input/output device that controls the grouping algorithm; and
recording the groups of assets into a database and transmitting a report via the input/output device that includes a statistical summary of how the assets are configured into the groups.

12. The method of claim 11, wherein the pre-partition rule includes at least one of the following:
cluster: let X be an asset property that takes on any value from a list of possible values, where a list of disjoint clusters of values is defined such that two assets must occur in different parts of the pre-partition if their values for property X are in different clusters;
match: let Y be an asset property and two assets must occur in different parts of the pre-partition if their values for property Y are not equal; and
range: let Z be an asset property with a total ordering such that all possible values of Z can be ordered, and sub-ranges of values are defined such that two assets must occur in different parts of the pre-partition if their values for property Z are not in the same sub-range.

13. The method of claim 12, wherein a property that describes a network of assets that determines necessary, but not sufficient, requirements for membership in the same group is selected.

14. The method of claim 13, wherein any pre-partition rule can optionally be enforced as at least one of a sufficient condition rather than a necessary condition for membership in the same pre-partition part and a complement of the pre-partition rule.

15. The method of claim 13, wherein each pre-partition is further divided into connected components of the network, where connections that join assets from distinct pre-partition parts are not allowed, and a connected component is a maximal set of network assets within which there is at least one path of network connections between each pair of assets.

16. The method of claim 11, wherein the match rule includes an aggregate-max on any numerical asset property, where Y is the numerical asset property and an upper bound on the value of property Y is defined such that the value of Y aggregated over the assets in any group chosen by the grouping algorithm, and having more than one asset, may not exceed the bound.

17. The method of claim 11, wherein the grouping algorithm reduces sizes of the groups based upon the aggregate-max.

18. The method claim 11 further comprising providing an input-map that includes a geographical representation of the assets on the input-map, which enables asset selection by a user.

19. The method of claim 11 further comprising providing an output-map that shows the groups determined.

20. A non-transitory computer readable storage medium having stored thereon a plurality of instructions that when executed by a processor of an asset management apparatus perform a method for asset management comprising:
receiving a selection of assets identified via an input/output device, the selection of assets chosen based upon search criteria for each asset of a plurality of assets;
pre-partitioning the assets based upon a pre-partition rule, the pre-partitioning including selected criteria entered via the input/output device that controls the pre-partition rule;
applying a grouping algorithm to the pre-partitioned assets to further sort the assets into groups which includes one or more variables entered via the input/output device that controls the grouping algorithm; and
recording the groups of assets into a database and transmitting a report via the input/output device that includes a statistical summary of how the assets are configured into the groups.

21. The non-transitory computer readable storage medium of claim 20, wherein the pre-partition rule includes at least one of the following:
cluster: let X be an asset property that takes on any value from a list of possible values, where a list of disjoint clusters of values is defined such that two assets must occur in different parts of the pre-partition if their values for property X are in different clusters;
match: let Y be an asset property and two assets must occur in different parts of the pre-partition if their values for property Y are not equal; and
range: let Z be an asset property with a total ordering such that all possible values of Z can be ordered, and sub-ranges of values are defined such that two assets must occur in different parts of the pre-partition if their values for property Z are not in the same sub-range.

22. The non-transitory computer readable storage medium of claim 20, wherein each pre-partition is further divided into connected components of a network, where connections that join assets from distinct pre-partition parts are not allowed, and a connected component is a maximal set of network assets within which there is at least one path of network connections between each pair of assets.
